(19) United States
(12) Patent Application Publication
(10) Pub. No.: US 2007/0013727 A1
(43) Pub. Date: Jan. 18, 2007

(54) Ink level detecting apparatus having optical fiber to detect the ink level in inkjet printer

(75) Inventor: Sung-june Jung, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/453,031

(22) Filed: Jun. 15, 2006

(30) Foreign Application Priority Data
Jul. 15, 2005 (KR) 2005-64066

(51) Int. Cl. B41J 2/195; B41J 29/393; B41J 2/175

(52) U.S. Cl. 347/7; 347/19; 347/86

(57) ABSTRACT

An ink level detecting apparatus usable with an inkjet printer, which uses an optical fiber to detect the ink level. The ink level detecting apparatus includes: an ink tank having an ink outlet; an optical fiber disposed near the ink tank; a light source which is disposed at a front end of the optical fiber and emits light; a light receiving sensor which is disposed at a rear end of the optical fiber and senses light propagating through the optical fiber; and a pressuring unit which presses the optical fiber so as to bend the optical fiber according to the weight of the ink tank.

### CROSS-REFERENCE TO RELATED APPLICATIONS

This application claims the priority of Korean Patent Application No. 2005-64066, filed on Jul. 15, 2005 in the Korean Intellectual Property Office, the disclosure of which is incorporated herein in its entirety by reference.

### BACKGROUND OF THE INVENTION

1. Field of the Invention

The present general inventive concept relates to an ink level detecting apparatus usable with an inkjet printer, and more particularly, to an ink level detecting apparatus that can continuously detect in real time the level of ink remaining in an ink tank using an optical fiber.

2. Description of the Related Art

Generally, in an inkjet printer, ink contained in an ink tank is supplied via a predetermined ink supply path to an ink ejecting unit having ink ejecting heads, and then the ink is ejected in micro droplets via the ink ejecting heads. Therefore, as the inkjet printer performs a printing job, the level of ink remaining inside the ink tank decreases.

A relatively accurate measurement of the ink remaining inside the ink tank, that is, the ink level, is required for inkjet printers. In particular, a user should be notified when the level of ink is close to the bottom of the ink tank and there is not enough remaining ink so that printing of a new page can be terminated. The reasons to stop printing a new page when there is not a sufficient amount of ink remaining are as follows.

First, if ink is ejected until all the ink is exhausted, an ink ejecting head can get damaged. For example, when a thermal method is used to eject ink, a heating element is rapidly heated to heat the ink accommodated inside an ink cell to expand the ink and force an ink droplet out of a nozzle. If the heating element is heated when there is no ink inside the ink cell, the heating element or peripheral elements may get damaged. Therefore, an allowable minimum amount of ink remaining in the ink cell must be reliably detected in order to prevent damage of the ink heads.

Second, when ink is exhausted and a printing job is stopped during the middle of printing, the partially printed paper and ink printed thereon will be discarded. Thus, whether there is enough ink for printing at least one page should be detected before printing in order to avoid wasting paper and time.

U.S. Pat. No. 5,997,121 and Japanese Patent Publication No. 1994-099588 disclose conventional devices to detect the level of ink. The former discloses a low ink sensing system including two light sources and one photodetector, wherein a difference in the amount of light reflected by an inclined structure provided at a predetermined level of an ink container is detected, the difference being caused by the level of ink in the ink container. The latter discloses an ink run-out detector which detects whether the level of ink is at a predetermined level using reflection type optical switches including a light source and a photodetector.

However, the conventional devices merely indicate whether the ink level has reached a predetermined critical level. That is, the conventional devices do not inform a user of the current ink level in an inkjet printer before the ink level reaches the critical level. Thus, the user cannot predict when the ink will be exhausted or how many more pages can be printed using the conventional devices.

### SUMMARY OF THE INVENTION

The present general inventive concept provides an ink level detecting apparatus that can continuously detect in real time the level of ink remaining in an ink tank using an optical fiber.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing an ink level detecting apparatus usable with an inkjet printer, including: an ink tank having an ink outlet; an optical fiber disposed near the ink tank; a light source which is disposed at a front end of the optical fiber and emits light; a light receiving sensor which is disposed at a rear end of the optical fiber and senses light propagating through the optical fiber; and a pressuring unit which presses the optical fiber so as to bend the optical fiber according to the weight of the ink tank.

The ink tank stores ink, and the ink is supplied to an ink ejecting head via the ink outlet. The ink outlet has a connection structure blocking an external force applied to the ink tank. The ink tank may be directly connected to an ink ejection unit including the ink ejecting head, or via a very flexible tube.

The optical fiber is a thin flexible fiber through which the light propagates. The optical fiber includes a core having a relatively high refractive index and a clad having a relatively small refractive index and which surrounds the core. The optical fiber may be any known conventional optical fiber. When the refractive indices of the core and the clad are smaller, the sensitivity to the change of light intensity due to the curvature change of the optical fiber increases.

The light source may be any of various light sources such as an LED and a laser diode. A light source which emits near infrared (IR) light when signals are transmitted via an optical fiber may be used. However, to increase the sensitivity to the change of the light intensity due to the curvature change of the optical fiber, a light source which emits light of a relatively short wavelength may be also used. In addition, the light source and the optical fiber may be formed in a single body in order to increase the efficiency and uniformity of incident light.

The pressuring unit has a plurality of protrusions, changes the curvature of the optical fiber according to the weight of the ink tank by concentrating the load of the ink tank to the protrusions, and presses the optical fiber from both sides. The optical fiber is slightly elastic, and thus the degree of the curvature change of the optical fiber depends on the magnitude of the applied weight. A predetermined tension may be applied to the optical fiber to have an appropriate curvature according to the weight of the ink tank. In addition, the optical fiber may be freely changed according to the displacement of the ink tank, and a separate elastic element may support the ink tank, wherein the displacement of the ink tank is approximately proportional to the weight of the ink tank.

As such, when the curvature of the optical fiber changes according to the weight of the ink tank, light scatters in an area where the curvature changes and light energy is reduced, thereby reducing the intensity of light at the rear end of the optical fiber. Such a change of the light intensity has a predetermined relationship with the curvature change of the optical fiber, and the degree of the curvature change of the optical fiber has a predetermined relationship with the weight of the ink tank. Therefore, the weight change of the ink tank, that is, the ink consumption, can be detected by detecting the change of the light intensity.

The light receiving sensor may emit constant electrical signals depending on the incident light. Also, the light receiving sensor may have a relatively high sensitivity regarding the wavelength of the light that is usually emitted by the light source. A convex lens may be disposed in an optical path from the rear end of the optical fiber to the light receiving sensor to concentrate light within a light receiving area.

The foregoing and/or other aspects and utilities of the present general inventive concept are also achieved by providing an ink level detecting apparatus for an inkjet printer, including an ink tank having an ink outlet; and a pressure sensing unit disposed below the ink tank and senses a pressure of the ink tank thereon based on a changing weight of the ink tank as ink is consumed through the ink outlet.

The pressure sensing unit can provide a sensing signal having a value directly proportional to the weight of the ink tank.

The foregoing and/or other aspects and utilities of the present general inventive concept are also achieved by providing an ink level detecting apparatus for an inkjet printer, including an ink tank having an ink outlet; and a displacement unit disposed adjacent to the ink tank to sense a displacement of the ink tank thereon based on a changing weight of the ink tank as ink is consumed through the ink outlet.

The foregoing and/or other aspects and utilities of the present general inventive concept are also achieved by providing a method of determining an ink level of an ink tank usable in an ink jet printer, the method including detecting a weight of the ink tank continuously as ink is consumed during printing operations; and determining an amount of ink remaining in the ink tank based on the detected weight of the ink tank.

The determining can include generating a signal corresponding to the detected weight of the ink tank.

The foregoing and/or other aspects and utilities of the present general inventive concept are also achieved by providing a method of determining an ink level of an ink tank usable in an ink jet printer, the method including detecting a displacement of the ink tank continuously as ink is consumed during printing operations; and determining an amount of ink remaining in the ink tank based on the detected displacement of the ink tank.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view of an ink level detecting apparatus according to an embodiment of the present general inventive concept;

FIG. 2 is a schematic diagram illustrating a principal of detecting the amount of remaining ink using an optical fiber, according to an embodiment of the present general inventive concept;

FIG. 3 is a graph illustrating a relationship between ink consumption and a signal level of a light receiving sensor, according to an embodiment of the present general inventive concept;

FIG. 4 is a view of an ink level detecting apparatus according to another embodiment of the present general inventive concept; and

FIG. 5 is a view of an ink level detecting apparatus according to another embodiment of the present general inventive concept.

### DETAILED DESCRIPTION OF THE PREFERRED EMBODIMENTS

The present invention will now be described more fully with reference to the accompanying drawings, in which exemplary embodiments of the invention are shown. Like reference numerals in the drawings denote like elements, and thus their description will be omitted.

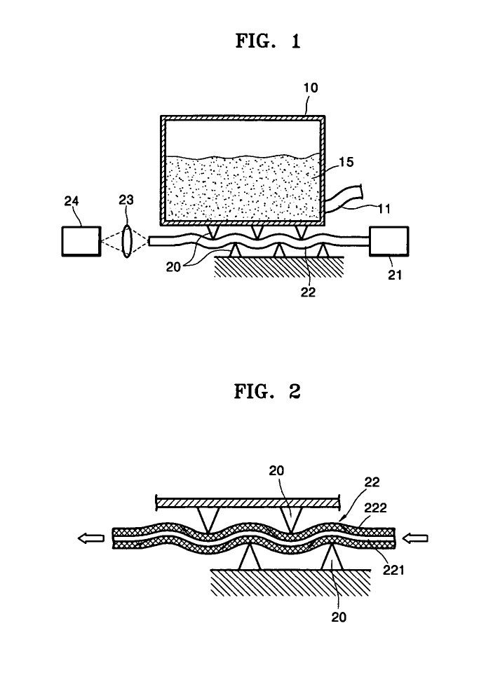

FIG. 1 is a view of an ink level detecting apparatus according to an embodiment of the present general inventive concept. An ink tank 10 stores ink and has an ink outlet 11 at a bottom portion thereof. The ink outlet 11 is connected to an ink ejection unit (not shown) via a flexible tube to minimize an external force applied to the ink tank 10.

An optical fiber 22 is disposed below the ink tank 10, and a pressuring unit 20 to bend the optical fiber 22 according to the weight of the ink tank 10 are disposed near the optical fiber. The pressuring unit 20 may include a plurality of upper protrusions that protrude from the bottom surface of the ink tank 10 and a plurality of lower protrusions protruding from a surface facing the upper protrusions. The optical fiber 22 is disposed between the upper and lower protrusions. The upper and lower protrusions may have narrow edges which contact the optical fiber 22, that is, they may have a triangular shape in order to concentrate the pressure applied to the optical fiber 22.

A light source 21 is disposed at a front end of the optical fiber 22, and a convex lens 23 and a light receiving sensor 24 are disposed at a rear end of the optical fiber 22. The light source 21 may be integrated with the optical fiber 22 so that uniform light is incident on the optical fiber 22 at an incident angle within a predetermined range (which satisfies a total internal reflection condition in a straight optical fiber). The convex lens 23 may be a micro lens corresponding to the thickness of the optical fiber 22. The convex lens 23 concentrates the light emitted from a core of the optical fiber 22 to a light receiving area of the light receiving sensor 24. The light receiving sensor 24 generates continuous electrical signals according to the intensity of the incident light. The light receiving sensor 24 may be a conventional sensor using a photoelectric effect.

FIG. 2 is a schematic diagram illustrating a principal of detecting an amount of remaining ink using an optical fiber, according to an embodiment of the present general inventive concept. An optical fiber 22 which transmits light from a light source to a light receiving sensor includes a core 221 having a relatively high refractive index and a clad 222 which surrounds the core 221 and has a relatively low reflective index. According to Snell's law, when light is incident on the interface between the core 221 and the clad 222 having different reflective indices, if the incident angle of the incident light is higher than a critical angle, a total internal reflection of light occurs and the light propagates along the core 221. However, if the incident angle of the incident light is lower than the critical angle, part of the light is reflected towards the clad 222 and emitted to the outside.

However, if the optical fiber 22 is curved as illustrated in FIG. 2, part of the light propagating along the core 221 is incident on the interface between the core 221 and the clad 222 at a smaller incident angle than the critical angle. Thus the light is scattered, that is, loss of light appears. Such light loss tends to increase as the curvature of the optical fiber 22 increases.

Therefore, if the relationship between the change in the load of the ink tank and the loss of light through the optical fiber 22 is calibrated, then the weight change of the ink tank, that is, the ink consumption amount, can be detected through the change of the light intensity sensed by the light receiving sensor. In addition, since the curvature change of the optical fiber caused by the weight change of the ink tank occurs continuously, the ink consumption amount can also be continuously detected.

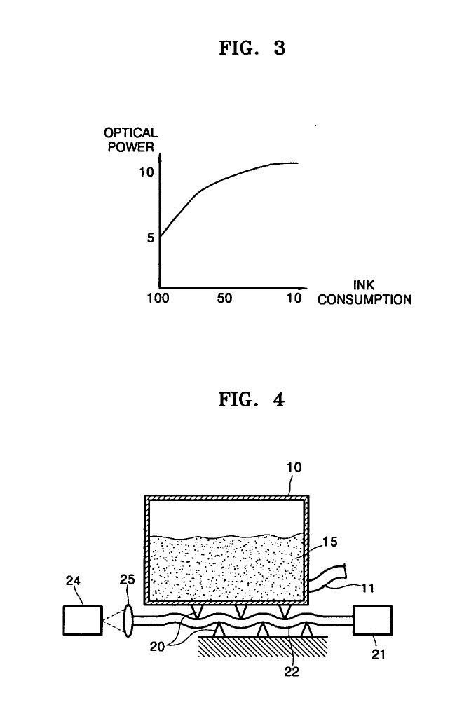

FIG. 3 is a graph illustrating the relationship between the ink consumption and a signal level of the light receiving sensor 24, according to an embodiment of the present general inventive concept. As the ink consumption increases, the curvature change of the optical fiber 22 decreases and light loss due to scattering also decreases. Thus, the signal level (i.e., the optical power) of the light receiving sensor 24 tends to continuously increase.

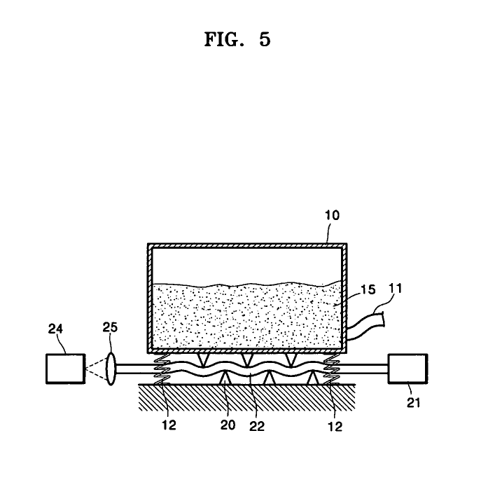

FIG. 4 is a view of an ink level detecting apparatus according to another embodiment of the present general inventive concept. The ink level detecting apparatus of the present embodiment is similar to that of the previous embodiment, except for a convex lens 25 which is placed at the rear end of an optical fiber 22 and is integrated with the optical fiber 22. Such an integrated lens structure can be obtained by processing a rear end of the optical fiber 22 using methods such as an acryl discharge or a micro process.

FIG. 5 is a view of an ink level detecting apparatus according to another embodiment of the present general inventive concept. The optical fiber 22 in the present embodiment does not mainly support the weight of an ink tank 10. Thus, the optical fiber 22 is disposed to be able to change the curvature thereof according to the displacement of the ink tank 10. In addition, the ink level detecting apparatus may further include an elastic element 12, a deformation of which is approximately proportional to the weight of the ink tank 10.

According to the ink level detecting apparatus for an inkjet printer of the various embodiments of the present general inventive concept, an ink level is continuously determine using an optical fiber, so that a user can predict the time when ink will be exhausted or how many papers can be printed thereon.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink level detecting apparatus usable with an inkjet printer, comprising:
an ink tank having an ink outlet;
an optical fiber disposed near the ink tank;
a light source which is disposed at a front end of the optical fiber and emits light;
a light receiving sensor which is disposed at a rear end of the optical fiber and senses light propagating through the optical fiber; and
a pressuring unit which presses the optical fiber so as to bend the optical fiber according to the weight of the ink tank.

2. The ink level detecting apparatus of claim 1, wherein the pressuring unit comprises:
a plurality of upper protrusions protruding from a bottom surface of the ink tank; and
a plurality of lower protrusions protruding from a surface facing the bottom surface of the ink tank, wherein the upper protrusions and lower protrusions alternate with each other.

3. The ink level detecting apparatus of claim 2, wherein the upper and lower protrusions are have triangular shapes with narrow edges which contact the optical fiber.

4. The ink level detecting apparatus of claim 1, wherein the light receiving sensor continuously generates electrical signals according to the intensity of incident light thereon from the optical fiber.

5. The ink level detecting apparatus of claim 1, further comprising:
a convex lens disposed between the rear end of the optical fiber and the light receiving sensor to concentrate the light from the optical fiber.

6. The ink level detecting apparatus of claim 5, wherein the convex lens is integrated with the rear end of the optical fiber.

7. The ink level detecting apparatus of claim 6, wherein the integrated lens structure is obtained by processing a rear end of the optical fiber using a method of either an acryl discharge or a micro process.

8. The ink level detecting apparatus of claim 5, wherein the convex lens is a micro lens corresponding to a thickness of the optical fiber.

9. The ink level detecting apparatus of claim 1, wherein the optical fiber includes a core having a relatively high refractive index and a clad which surrounds the core and has a relatively low reflective index.

10. The ink level detecting apparatus of claim 1, further comprising: an elastic element which supports the ink tank, and a displacement of the ink tank is approximately proportional to the weight of the ink tank.
